(19) United States
(12) Patent Application Publication
(10) Pub. No.: US 2011/0282009 A1
(43) Pub. Date: Nov. 17, 2011

(54) Free-radical Curable Isobutylene-rich Polymers

(76) Inventors: J. Scott Parent, Kingston (CA); Ralph A. Whitney, Kingston (CA)

(21) Appl. No.: 13/108,049

(22) Filed: May 16, 2011

Related U.S. Application Data
(60) Provisional application No. 61/345,391, filed on May 17, 2010.

(51) Int. Cl. C08F 8/00; C08F 236/10; C08F 236/08

(52) U.S. Cl. 525/326.7; 526/262; 526/326; 526/340; 526/270; 525/327.2; 525/329.5; 525/332.9

(57) ABSTRACT

Halide displacement from brominated polyisobutylene-co-isoprene) (MIR) under homogeneous and phase-transfer catalyzed reaction conditions is used to prepare acrylate, styrenic and maleimide functionalized elastomers in high yield. These macro-monomer derivatives cross-link efficiently under peroxide initiation to give high modulus, thermoset products that cannot otherwise be accessed from isobutylene-rich elastomers. The extent of cure scales with content of activated C═C, and can extended by co-oligomerization of pendant unsaturation with that contained within multi-functional co-agents.

### FIELD OF THE INVENTION

The present invention relates to derivatization of isobutylene-rich elastomers to form modified isobutylene-rich elastomers that are capable of being crosslinked to form cured products using standard free-radical-initiated curing techniques.

### BACKGROUND OF THE INVENTION

Poly(isobutylene-co-isoprene), or IIR, is a synthetic elastomer commonly known as butyl rubber which has been prepared since the 1940's through random cationic copolymerization of isobutylene with small amounts of isoprene (1-2 mole %). As a result of its molecular structure, IIR possesses superior gas impermeability, excellent thermal stability, good resistance to ozone oxidation, exceptional dampening characteristics, and extended fatigue resistance.

In many of its applications butyl rubber is cross-linked to generate thermoset articles with greatly improved modulus, creep resistance and tensile properties. Alternate terms for crosslinked include vulcanized and cured. Crosslinking systems that are typically utilized for HR include sulfur, quinoids, resins, sulfur donors and low-sulfur, high-performance vulcanization accelerators. IIR can be halogenated to introduce allylic halide functionality that is reactive toward sulfur nucleophiles and toward Lewis acids such as organozinc complexes. As a result, materials such as brominated butyl rubber, or BIIR, crosslink more rapidly than HR when treated with standard vulcanization formulations.

Free-radical initiated curing techniques are valued when it is desirable to obtain cured articles that are substantially free of byproducts that include sulfur and/or metals. Although many commercially available elastomers are readily cured by currently available peroxide-initiated crosslinking techniques, poly(isobutylene-co-isoprene) is not (Loan, L. D. Pure Appl. Chem. 1972, 30, 173-180; Loan, L. D. Rubber Chem. Technol. 1967, 40, 149-176). Instead, under the action of organic peroxides, IIR suffers molecular weight losses by macro-radical fragmentation that are greater than any molecular weight gains obtained through macro-radical combination (Loan, L. D. J. Polym. Sci. Part A: Polym. Chem. 1964, 2, 2127-2134; Thomas, D. K. Trans. Faraday Soc. 1961, 57, 511-517).

In addition to failing to cure by peroxide-initiated crosslinking techniques, IIR also fails to cure appreciably under standard co-agent-based cure formulations, as evidenced by low yields observed for poly(isobutylene) grafting to acrylate, styrenic, and maleimide functionality (Kato, M. et al. J. Polym. Sci. Part A: Polym. Chem. 2006, 44, 1182-1188; Abbate, M. et al. J. Appl. Polym. Sci. 1995, 58, 1825-1837). IIR grades with isoprene content in excess of 4 mol % have been developed, that cure when mixed with significant quantities of peroxide (1 to 5 wt %) and co-agents such as N,N′-m-phenylenedimaleimide (2.5 wt %) (Asbroeck, E. V. et al., Canadian Patent No. 2,557,217 (2005). These high initiator and co-agent loadings resulted in expensive cure formulations, and vulcanizates that contained high levels of initiator-byproducts such as ketones and alcohols.

Oxely and Wilson used a cationic copolymerization of isobutylene and divinylbenzene monomers to prepare an isobutylene-rich elastomer that responded positively to peroxide-initiated cross-linking (Oxely, C. E.; Wilson, G. J. Rubber Chem. Technol. 1969, 42, 1147-1154). However, the activation of both vinyl groups during the polymerization process yielded a product that contained a very high gel content indicating that the product was only partially crosslinked. The high gel content negatively impacted the material's processing characteristics. Thus, there exists a need for a halogen-free and metal-free IIR derivative that can efficiently crosslink under standard free-radical crosslinking techniques and that does not require excessive free-radical initiation.

Therefore, there exists a need for a halogen-free and metal-free isobutylene-rich polymer that cures efficiently without need for excessive free-radical initiation, and for articles made therefrom.

### SUMMARY OF THE INVENTION

In a first aspect, the invention provides a macromonomer, which comprises a polymeric main chain comprising an olefinic moiety, and a plurality of side chains that comprise a polymerizable C═C moiety; wherein the polymerizable C═C moiety is a substituted or unsubstituted styrenic moiety, a substituted or unsubstituted vinylbenzoate, or a substituted or unsubstituted maleimido moiety; and which is a polymer that homopolymerizes when initiated by a free-radical initiator. In certain embodiments of the first aspect, the macromonomer is a poly(isobutylene-co-isoprene) derivative, a poly(isobutylene-co-methylstyrene) derivative, or a polyolefin derivative. In embodiments of the first aspect, substituents of the substituted styrenic moiety, the substituted vinylbenzoate or the substituted maleimido moiety are functional substituents. In certain embodiments of the first aspect, the polymerizable C═C moiety comprises styrene, ascorbate, cinnamate, 2-vinylbenzoate, 3-vinylbenzoate, 4-vinylbenzoate, 4-maleimidobenzoate, 3-maleimidobenzoate, 2-maleimidobenzoate, maleimidocaproicate, or a combination thereof. In certain embodiments of this aspect, the polymerizable C═C moiety is substituted.

In a second aspect, the invention provides a crosslinked macromonomer prepared by reacting the macromonomer of the first aspect with a free-radical initiator.

In a third aspect, the invention provides an innerliner composition that comprises the crosslinked macromonomer of the second aspect.

In embodiments of the above aspects, the free-radical initiator is: a chemical free-radical initiator, a photoinitiator, heat, heat in the presence of oxygen, electron bombardment, irradiation, high-shear mixing, photolysis (photo-initiation), electron beam radiation, or radiation bombardment. In some embodiments, the chemical free-radical initiator is an organic peroxide, a hydroperoxide, bicumene, dicumyl peroxide, di-t-butyl peroxide, an azo-based initiator, or homolysis of an organic peroxide.

In a fourth aspect, the invention provides polyisobutylene-co-isoprene) having vinylbenzoate ester pendant groups.

In a fifth aspect, the invention provides poly(isobutylene-co-isoprene) having maleimidobenzoate pendant groups.

In a sixth aspect, the invention provides poly(isobutylene-co-methystyrene) having vinylbenzoate ester pendant groups.

In a seventh aspect, the invention provides poly(isobutylene-co-methystyrene) having maleimidobenzoate pendant groups.

In an eighth aspect, the invention provides a method of crosslinking isobutylene-rich elastomers, that comprises: modifying halogenated isobutylene-rich elastomers to form halo-free elastomers by replacing substantially all halide substituents with polymerizable groups that comprise a polymerizable C═C moiety; exposing the halo-free elastomers to a free-radical initiator; and allowing reactions to occur such that crosslinking-bonds form and cured product is obtained. In an embodiment of the eighth aspect, the polymerizable C═C moiety comprises: a substituted or unsubstituted styrenic moiety, a substituted or unsubstituted vinylbenzoate, or a substituted or unsubstituted maleimido moiety.

In a ninth aspect, the invention provides a method for making macromonomer that comprises: esterifying Exo-Br by reacting it with R¹₄N⁺R²COO⁻; and obtaining E,Z-ester, Exo-ester, and R¹₄NBr. An embodiment of the ninth aspect further comprises removing substantially all R¹₄NBr from the esterification product.

In a tenth aspect, the invention provides a method for making macromonomer that comprises: isomerizing Exo-Br; obtaining E,Z-BrMe; esterifying E,Z-BrMe by reacting it with R¹₄N⁺R²COO⁻; and obtaining E,Z-ester and R¹₄NBr. An embodiment of the tenth aspect further comprises purifying E,Z-ester.

In an eleventh aspect, the invention provides a method for making macromonomer comprising: reacting Exo-Br with K+RCOO— and R¹₄N⁺Br; and obtaining E,Z-ester, Exo-ester and KBr.

In a twelfth aspect, the invention provides a kit that comprises: macromonomer of the first aspect; optionally, a free-radical initiator; and instructions for use of the kit that include directions to subject the macromonomer to free-radical initiation to form a cross-linked polymer.

In an embodiment of the twelfth aspect, the instructions comprise printed material, text or symbols provided on an electronic-readable medium, directions to an internet web site, or electronic mail.

### BRIEF DESCRIPTION OF THE DRAWINGS

For a better understanding of the invention and to show more clearly how it may be carried into effect, reference will now be made by way of example to the accompanying drawings, which illustrate aspects and features according to embodiments of the present invention, and in which:

FIG. 1 is a schematic showing three synthetic methodologies used to prepare macromonomers of IIR by BIIR esterification chemistry.

FIGS. 2A-C show an evolution of allylic bromide and acrylate ester concentrations in solution-borne IIR-g-AA preparations (10 wt % BIIR in toluene; 85° C.).

FIG. 3 shows final amounts of acrylate and vinylbenzoate ester contents of BIIR macromonomers as a function of nucleophile mixture composition (5 wt % BIIR in toluene, 1.5 eq Bu₄N⁺RCOO⁻ total; T=85° C., 3 hr; ♦ Nu is VBA; ⋄ Nu is AA).

FIG. 4 shows dynamics of peroxide-initiated IIR-g-AA crosslinking under different peroxide initiator concentrations (0.15 mmol/g acrylate; 170° C.).

FIG. 5 shows peroxide-initiated cure yields of IIR-g-AA/stearate and IIR-g-VBAlstearate ([DCP]=0.3 wt %; 170° C.).

FIG. 6 shows dynamics of IIR-g-AA and co-agent-assisted IIR-g-AA cures (0.15 mmol/g reactive functionality; 170° C.).

FIG. 7 shows dynamics of IIR-g-MBA crosslinking under different peroxide initiator concentrations (0.15 mmol/g maleimide functionality; 160° C.).

FIG. 8 shows dynamics of crosslinking for unfilled IIR-g-MBA, IIR-g-MBA filled with 30 wt % of silica, and IIR-g-MBA filled with 30 wt % of carbon black (0.15 mmol/g maleimide functionality; 0.6 wt % DCP; 160° C.).

### DETAILED DESCRIPTION OF THE INVENTION

As discussed above, using previously known technology, it was not possible to cure butyl rubber using standard radical initiation techniques (e.g., using peroxides). As described herein, it has been discovered that performing a modification to butyl rubber allows the isobutylene-rich elastomers to cure efficiently when activated by free-radical initiator. Processes of the present invention introduce polymerizable functionality to HR with no significant change in the number average molecular weight of the starting polymer.

Aspects of the present invention provide isobutylene-rich elastomers that are capable of being cured using free-radical initiation methods (known herein as “macromonomers”). Other aspects of the present invention provide a process for making macromonomers. Further aspects of the invention provide a method of making crosslinked butyl rubber using standard free-radical crosslinking techniques. The following terms will be used in this description.

### DEFINITIONS

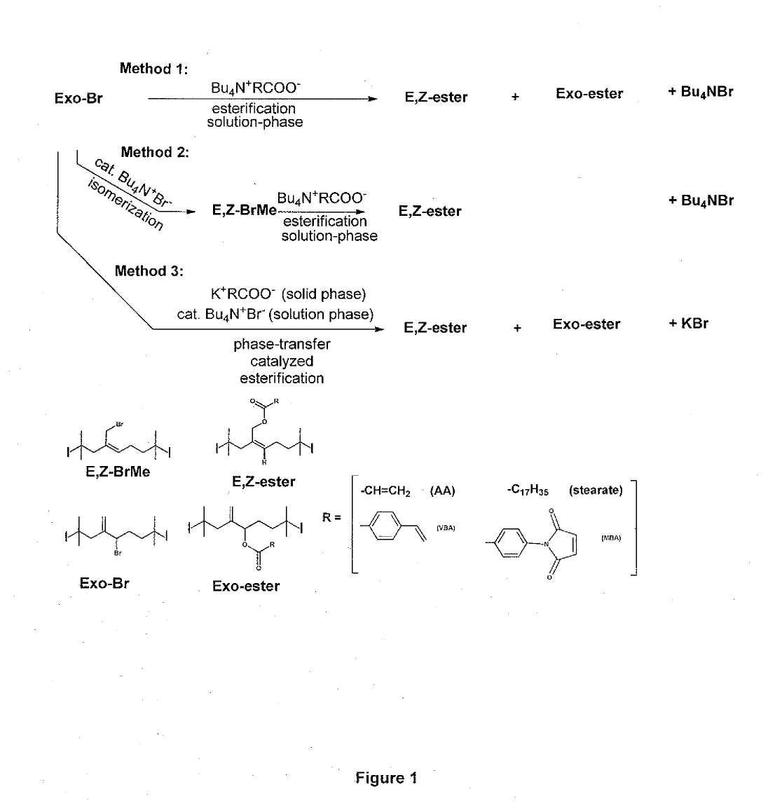

As used herein: “AA” means acrylic acid; “DCP” means dicumyl peroxide; “VBA” means vinylbenzoic acid; “MBA” means maleimidobenzoic acid; and “BHT” means butylated hydroxytoluene. Structural formulae of AA, stearate, VBA and MBA are shown in FIG. 1.

As used herein, the term “activating” means increasing the reaction rate of chemical reaction. Analogously, an “activator” is a species whose presence increases the chemical reaction rate of, in most cases herein, a free-radical polymerization reaction. As used herein, the term “activated C═C moiety” means a doubly bonded carbon-carbon moiety that is conjugated to an activator.

As used herein, “aliphatic” is intended to encompass saturated or unsaturated hydrocarbon moieties that are straight chain, branched or cyclic and, further, the aliphatic moiety may be substituted or unsubstituted.

As used herein, the term “IIR” means poly(isobutylene-co-isoprene), a synthetic elastomer commonly known as butyl rubber that typically has less than 4 mole % isoprene. As used herein, the term “BIIR” means brominated butyl rubber. As used herein, the term “CIIR” means chlorinated butyl rubber. As used herein, the term “BIMS” means brominated poly(isobutylene-co-para-methylstyrene).

As used herein, the term “conjugated” refers to covalently bonded atoms that influence each other to produce a region of electron delocalization where electrons do not belong to a single bond or atom, but rather to a group. Conjugation is possible when each contiguous atom in a chain possesses a p-orbital forming a pi bond. A first example of conjugation is a hydrocarbon chain with alternating single and multiple (e.g., double) bonds between the carbon atoms (e.g., C═C—C═C). A second example includes a hydrocarbon chain that includes heteroatoms with alternating single and multiple bonds (e.g., C═C—C═O).

As used herein, the terms “curing”, “vulcanizing”, or “crosslinking” of a polymer refers to formation of covalent bonds that link one polymer chain to another thereby altering the properties of the material.

As used herein, the term “free-radical polymerizable” means able to polymerize when initiated by a free-radical initiator. As used herein, the term “free-radical curing” means crosslinking or curing that is initiated by free-radical initiators, which include chemical initiators, photoinitiators or radiation bombardment.

As used herein, the terms “functional group” and “FG” refer to a moiety comprising alkyl, aryl, phenyl, halogen, silane, alkoxysilane, phenolic, aryl alcohol, ether, thioether, aldehyde, ester, thioester, dithioester, carbonate, carbamate, amide, imide, nitrile, imine, enamine, -olefin, vinyl, alkyne, phosphate, phosphonate, phosphonium, sulfate, sulfonate, sulfoxide, ammonium, imidazolium, pyridinium, thiazolium and combinations thereof.

As used herein, the term “functional nucleophile” means a reagent bearing a functional group, defined above, and a nucleophilic moiety that is capable of ring-opening an anhydride.

As used herein, the term “macromonomer” means a polymer with pendant functional groups that are capable of polymerization under free-radical curing.

As used herein, the term “nucleophilic substitution” refers to a class of substitution reaction in which an electron-rich nucleophile bonds with or attacks a positive or partially positive charge of an atom attached to a leaving group. In certain examples herein, nucleophilic substitution refers to displacement of a halide from MIR by a nucleophilic reagent and includes esterification.

As used herein, the term “pendant group” means a moiety that is attached to a polymer backbone.

As used herein, the terms “polymer backbone” and “PB” mean the main chain of a polymer to which pendant group is attached.

As used herein, the term “radical generating technique” means a method of creating free radicals, including the use of chemical initiators, photo-initiation, radiation bombardment, thermo-mechanical processes, oxidation reactions or other techniques known to those skilled in the art.

### Description

Aspects of the present invention provide elastomers that are capable of being cured using radical generating techniques. For clarity, the term “macromonomer” is used herein to describe polymers comprising a polymer backbone and a plurality of pendant functionality that contain polymerizable C═C groups. Aspects of the present invention provide isobutylene-rich elastomers bearing a plurality of pendant groups that each comprise a free-radical-polymerizable activated C═C functionality. As those with skill in the art of the invention will recognize, a polymer may have many pendant groups attached and when a polymer is crosslinked many crosslinks are formed. Accordingly, for clarity in the discussion herein, a singular pendant group may be described to represent what is happening at a plurality of sites.

Macromonomers have been synthesized and characterized as described herein. These macromonomers have been crosslinked using free-radical curing conditions. Their cured products have been characterized and results are presented herein. The macromonomer's ability to free-radical cure is in contrast to IIR, which does not cure by free-radical initiation, and is in contrast to BIIR, which partially cures under free-radical initiation and produces a partially cured product with a low storage modulus.

Other aspects of the present invention provide a process for making macromonomers. Further aspects of the invention provide a method of making cross-linked products by curing (again, using radical generating techniques). Certain aspects of the invention provide products made from crosslinked elastomers that are produced by the curing of macromonomers.

As described briefly above, aspects of the present invention provide isobutylene-rich elastomers bearing pendant groups that each comprise a free-radical-polymerizable C═C functionality. A free-radical polymerizable C═C olefin functionality is a moiety that includes a carbon-carbon double bond that is conjugated to a moiety that activates the olefin toward radical addition; such an activating moiety is known herein as an “activator”.

An activator increases the reaction rate of free-radical polymerization. Non-limiting examples of activators include aryl, carbonyl, acyloxy, amido, imido, ester, and cyano. Optionally, the activator can also link the pendant group to the polymer as shown in the below generic structure that has a moiety that acts as both “activator & linker”. Alternatively, the activator can be covalently attached to a separate linker that is covalently bonded to the polymer. In embodiments where the activator is separate from the linker, the activator may be bonded directly to the linker, or they may be separated by a spacer moiety. In some embodiments the activator is conjugated to the linker. See the structures below for representative generic structures of these moieties.

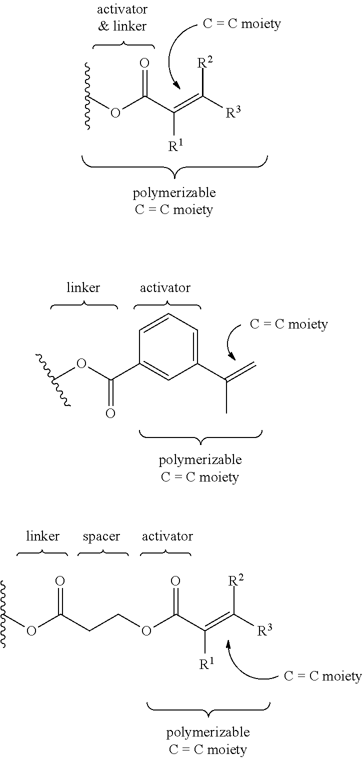

In the above structural formulae and elsewhere herein, a wiggly line is used to represent a remaining portion of a polymer molecule and is not intended to be limiting; the wiggly line can represent an attachment at the polymer's main chain, or optionally it can also represent atoms located between the moiety that is presented and the polymer's main chain. A suitable linker is inert when exposed to a radical generating technique, but is not otherwise restricted. A non-limiting example of a linker that provides a covalent link between polymer and a polymerizable C═C group is an ester, as illustrated below. Other non-limiting examples include amides, ethers and sulfides. In the ester linker embodiment of the invention, polymerizable C═C moieties can be conveniently bonded to IIR elastomers using an esterification reaction to react a substrate with BIIR and replace the Br substituent with the ester linker. Suitable examples of polymerizable C═C moieties and their substrates are presented in Table 1.

TABLE 1
Examples of pendant polymerizable C═C moieties

| | | substrate |
|---|---|---|
| | | ([cationic |
| | | counterion] |
| | | [anion]) |
| Entry | | where |
| No. | Structure | anion is: |
| 1 | 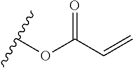 | acrylate |
| 2 | 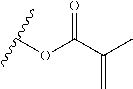 | methyl- acrylate |
| 3 | 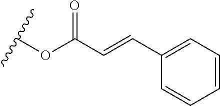 | cinnamate |
| 4 | 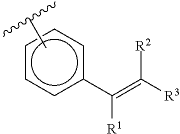 | styrenic moiety |
| 5 | 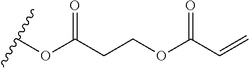 | 2-carboxy- ethyl acrylate |
| 6 | 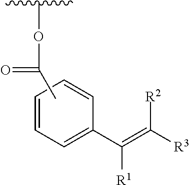 | styrenic ester |
| 7 | 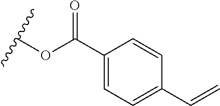 | 4-vinyl- benzoate |
| 8 | 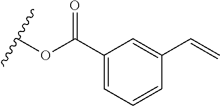 | 3-vinyl- benzoate |
| 9 | 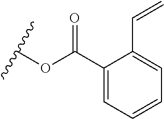 | 2-vinyl- benzoate |
| 10 | 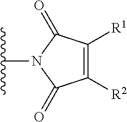 | maleimide |
| 11 | 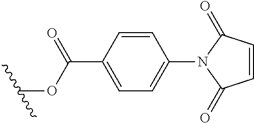 | maleimido- benzoate |
| 12 | 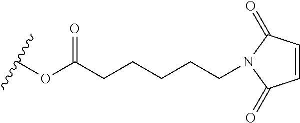 | maleimido- caproate |

In regard to styrenic moieties at entries 5 and 7 of Table 1, R¹, R², and R³ are independently hydrogen, C₁ to about C₁₂ aliphatic, or aryl. In some embodiments, aliphatic is alkyl. In certain embodiments of entries 5 and 7 of Table 1, at least one of R¹, R², and R³ is hydrogen. In some embodiments, at least two of R¹, R², and R³ are hydrogen. In further embodiments, all of R¹, R², and R³ are hydrogen. The covalent link between the styrenic moiety and the polymer may be ortho, meta, or para disposed to the C═C bond, and may include mixtures of these isomers.

In regard to the general formula for maleimide moieties at entry 11 of Table 1, R¹ and R² are independently hydrogen, C₁ to about C₁₂ aliphatic, or aryl. In some embodiments, aliphatic is alkyl. In certain embodiments, at least one of R¹, and R² is hydrogen. In some embodiments, both of R¹ and R² are hydrogen. Non-limiting examples of maleimide functionality include 4-maleimido benzoate whose covalent link to the polymer, is a para-benzoate ester, and maleimido caproate whose covalent link to the polymer is a hexanoate ester, as illustrated.

In an embodiment of the invention, a pendant group is attached to IIR elastomers by reacting an elastomeric precursor (e.g., BIIR) and a substrate (i.e., pendant group precursor). BIIR is a particularly useful elastomeric precursor, because its allylic bromide functional groups are reactive with respect to nucleophilic displacement (see Whitney, R. A. at al. Macromolecules 2005, 38, 4625-4629; Guillen-Castellanos, S. A. et al., J. Polym. Sci. Part A: Polym. Chem. 2006, 44, 983-992; Guillen-Castellanos, S. A. et al. Macromolecules 2006, 39, 2514-2520).

A substrate is conveniently added to a reaction mixture as a salt. In such a salt, the moiety that becomes the pendant group is the salt's anion and an unreactive counterion is the salt's cation. In such cases, the counterion should be chosen so that it does not interfere with the reaction. In FIG. 1, Bu₄N′ is shown as a non-limiting example of a counterion.

In the nucleophilic displacement reaction, a substrate is mixed with reactant BIIR. The substrate's anion comprises a nucleophilic moiety, which is known herein as the linker. During the reaction, a bond forms between the linker and an allylic carbon on BIIR and bromide is displaced. Non-limiting examples of nucleophilic linkers comprise nucleophilic oxygen, nucleophilic nitrogen and nucleophilic sulfur functional groups (e.g., carboxylate, thiolate, and amine). Conveniently, in the working examples described herein a carboxylate salt was reacted to produce a macromonomer with ester linkers in its pendant groups.

The polymer backbone to which curing functionality is attached is not particularly restricted, and the selection of a suitable polymer is within the purview of a person skilled in the art. As used through this specification, the term “polymer backbone” is intended to have a broad meaning and encompasses homopolymers of an olefin monomer, copolymers that comprise at least one olefin monomer, terpolymers that comprise at least one olefin monomer, etc.

As used throughout this specification, the term “olefin monomer” is intended to have a broad meaning and encompasses α-olefin monomers, diolefin monomers and polymerizable monomers containing at least one olefin linkage.

In an embodiment, the olefin monomer is an α-olefin monomer. α-Olefin monomers are well known in the art and the choice thereof for use in the present process is within the purview of a person skilled in the art. In certain embodiments, the α-olefin monomer is selected from the group comprising isobutylene, propylene, 1-butene, 1-pentene, 1-hexene, 1-octene, branched isomers thereof, styrene, α-methylstyrene, para-methylstyrene and mixtures thereof. Preferred α-olefin monomers are isobutylene and para-methylstyrene.

In another embodiment, the olefin monomer comprises a diolefin monomer. Diolefin monomers are well known in the art and the choice thereof for use in the present process is within the purview of a person skilled in the art. In one embodiment, the diolefin monomer is an aliphatic compound. Non limiting examples of suitable aliphatic compounds may be selected from the group comprising 1,3-butadiene, isoprene, 2,3-dimethyl-1,3-butadiene, 2-ethyl-1,3-butadiene, piperylene, myrcene, allene, 1,2-butadiene, 1,4,9-decatriene, 1,4-hexadiene, 1,6-octadiene, 1,5-hexadiene, 4-methyl-1,4-hexadiene, 5-methyl-1,4-hexadiene, 7-methyl-1,6-octadiene, phenylbutadiene, pentadiene and mixtures thereof. In another embodiment, the diolefin monomer is an alicyclic compound. Non-limiting examples of suitable alicyclic compounds may be selected from the group comprising norbornadiene, aliphatic derivatives thereof, 5-alkylidene-2-norbornene compounds, 5-alkenyl-2-norbornene compounds and mixtures thereof, such as 5-methylene-2-norbornene, 5-ethylidene-2-norbornene, 5-propenyl-2-norbornene and mixtures thereof. Further non-limiting examples of suitable alicyclic compounds may be selected from the group comprising 1,4-cyclohexadiene, 1,5-cyclooctadiene, 1,5-cyclododecadiene, methyltetrahydroindene, dicyclopentadiene, bicyclo[2.2.1]hepta-2,5-diene and mixtures thereof. A preferred diolefin monomer is isoprene.

It is possible to utilize mixtures of the various types of olefin monomers described hereinabove.

In an embodiment, the olefin is a mixture of isobutylene and at least one diolefin monomer. A particular such monomer mixture comprises isobutylene and isoprene. In this embodiment, it is preferred to incorporate into the mixture of isobutylene and isoprene from about 0.5 to about 3 mole percent of the diolefin monomer. In certain embodiments, about 1 to about 2 mole percent of the diolefin monomer is used.

In another embodiment, the olefin is a mixture of isobutylene and at least one α-olefin. A particular such monomer mixture comprises isobutylene and para-methylstyrene. In this embodiment, it is preferred to incorporate into the mixture about 0.5 to about 3 mole percent of the α-olefin monomer. In some embodiments, about 1 to about 2 mole percent of the α-olefin monomer is incorporated in the mixture.

An aspect of the present invention provides a method of preparing a macromonomer from a halogenated elastomer and a carboxylate nucleophile that contains a polymerizable C═C group.

In certain embodiments, the halogenated elastomer is BIIR, CIIR, BIMS or polychloroprene.

In an embodiment, polymerizable C═C groups are introduced to an isobutylene-rich polymer backbone by reaction of a halogenated elastomer and a carboxylate nucleophile. These reactions can be conducted under solvent-free conditions, or using a solvent that dissolves the halogenated elastomer. A non-limiting example is the reaction of BIIR with (Bu₄N⁺)(CH₂═CH-Ph-COO⁻) as illustrated below. As those with skill in the art of the invention will recognize, the macromonomer generated by this process has a polymer backbone made up of isobutylene and isoprene mers, and attached to the polymer backbone by an ester linker, multiple polymerizable C═C groups comprising styrenic moieties.

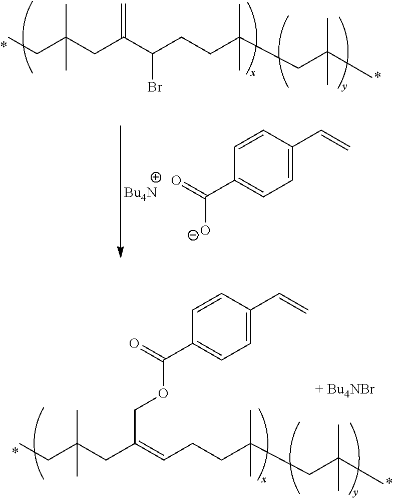

Another non-limiting example is the reaction of BIMS with a potassium carboxylate salt of maleimido benzoic acid as illustrated below. As those with skill in the art of the invention will recognize, the macromonomer generated by this process has a polymer backbone comprising isobutylene and para-methystyrene mers, multiple polymerizable C═C groups comprising a maleimide functionality that is attached to the polymer backbone by a benzoate ester linker.

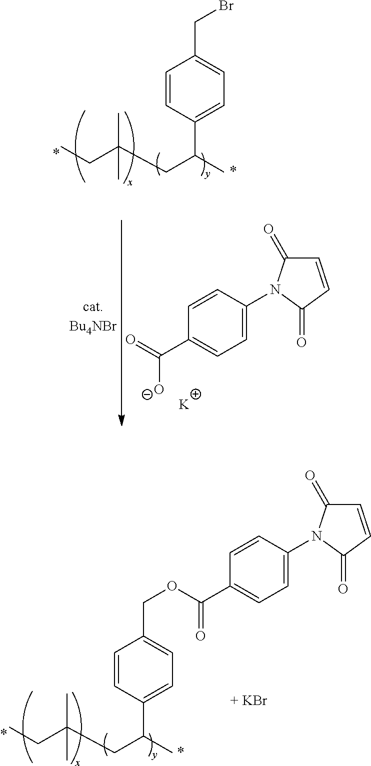

Where a carboxylate nucleophile is non-nucleophilic and/or insoluble in a reaction medium, it may be desirable to use a phase transfer catalyst to promote esterification. Typically, phase transfer catalysis involves the introduction of catalytic amounts of a phase transfer catalyst, such as a tetraalkylammonium halide, a polyether, or a crown ether. Phase transfer catalysts that are suitable for use in the present invention are not limited. Non-limiting examples of phase transfer catalysts are described in Monographs in Modern Chemistry No 11: Phase Transfer Catalysis, 2^{nd} ed.; Verlag Chimie: Germany, 1983. Certain phase transfer catalysts include tetrabutylammonium bromide, trioctylmethylammonium chloride, 18-crown-6, and mixtures thereof.

An aspect of the invention provides a method of making macromonomers. Three preparation methods are described herein (see FIG. 1), each differing in terms of substrate, cost and reaction time. Given the reactivity of acrylate, styrenic, and maleimide functionality, esterification rates can be important if a macromonomer is to be prepared without incurring undesirable side reactions such as premature crosslinking. Therefore, techniques that lead to rapid esterification at the lowest possible temperature are desirable.

Grades of BIIR that include calcium stearate may produce corresponding stearate ester byproducts in proportions that vary with reaction conditions. Therefore, preparation techniques that provide selectivity for the desired C═C-containing ester versus stearate ester are desirable.

A first method of preparing macromonomers includes esterifying BIIR in a solution using a nucleophilic carboxylate salt that dissolves in the reaction medium. The use of tetralkylammonium carboxylate salts under homogenous reaction conditions was shown to produce the desired esters in about 90 minutes at 85° C. Ninety minutes is a relatively fast reaction time for these allylic bromide sites (considerably faster than corresponding reactions at benzylic bromide sites that can require upwards of 10 hours). The resulting product included the desired product macromonomer and a stearate ester byproduct in an amount of less than 25%.

A second method of preparing macromonomers involves isomerizing BIIR prior to esterification (see FIG. 1). In this case, the Exo-Br, which is the allylic isomer that is predominant within commercially available BIIR, is rearranged to its corresponding E-BrMe and Z-BrMe isomers. These rearranged isomers react about 20 times faster toward carboxylate nucleophiles compared to Exo-Br. As a result, reactions of “isomerized BIIR” with Bu₄N⁺ carboxylate salts proceed to full conversion in much less time than corresponding reactions utilizing “as received BIIR”. Such improvements in reactivity provide cost savings and time savings. This second method provides an additional advantage in that reaction products generally contain less than 10 wt % stearate ester.

A third method (see FIG. 1) of preparing macromonomers involves phase-transfer catalysis techniques (Dehmlow, E. V. et al. Monographs in Modern Chemistry No 11: Phase Transfer Catalysis, 2nd ed.; Verlag Chimie: Germany, 1983; Fréchet, J. M. J. et al. J. Org. Chem. 1979, 44, 1774-1779; Fréchet, J. M. J. J. Macromol. Sci.-Chem. 1981, A15, 877-890) that employ small amounts of Bu₄NBr to transform alkali metal carboxylates into organic salts that are soluble in toluene and nucleophilic with respect to BIIR (Guillen-Castellanos, S. A. et al. Macromolecules 2006, 39, 2514-2520). This third method uses an alkali metal hydroxide base (e.g., KOH), the conjugate acid form of the carboxylate nucleophile and catalytic amounts of a quaternary ammonium halide to generate a macromonomer with KBr as a byproduct. This method has an advantage in that it does not generate large amounts Bu₄NBr byproduct, and less than 5% of allylic bromide functionality is converted to stearate ester.

Typical polymer backbones used in the present invention have a number-average molecular weight (Mn) in the range from about 10,000 to about 500,000. In some embodiments the Mn is from about 10,000 to about 200,000 or from about 60,000 to about 150,000. In certain embodiments, the Mn is from about 30,000 to about 100,000. It will be understood by those of skill in the art that reference to molecular weight refers to a population of polymer molecules and not necessarily to a single or particular polymer molecule.

Since macromonomer crosslinking involves free-radical oligomerization of pendant C═C functionality, the extent of cure provided by pure macromonomer is dictated by its polymerizable C═C content. Typically, the polymerizable C═C content of a macromonomer is from about 0.02 mmol/gram of polymer to about 0.50 mmol/gram of polymer. In some embodiments, C═C content is from about 0.05 to about 0.20 mmol/gram of polymer.

If the amount of polymerizable C═C functionality in a macromonomer is insufficient to provide the desired extent of crosslinking, then additional crosslinking can be gained by curing a mixture containing the macromonomer and a small amount of co-agent that contains two or more polymerizable C═C bonds. Common examples of such co-agents include trimethylolpropane triacrylate, triallyl trimellitate, and N,N′-m-phenylenedimaleimide. Typically, the co-agent content of these mixtures is from about 0.1 wt % to about 10 wt %. In certain embodiments, the co-agent content is from about 0.5 wt % to about 2 wt %.

In some embodiments, a macromonomer contains one or more fillers such as carbon black, precipitated silica, clay, glass fibres, polymeric fibres and finely divided minerals. Such additives are typically used to improve the physical properties of polymers, including abrasion resistance, stiffness and UV resistance. Typically, the amount of filler is from about 10 wt % to about 60 wt %. In some embodiments, filler content is from about 25 wt % to about 45 wt %.

In certain embodiments, a macromonomer contains one or more nano-scale fillers such as exfoliated clay platelets, sub-micron particles of carbon black, and sub-micron particles of mineral fillers such as silica. These nano-scale additives are typically used to improve the physical properties of polymers, including impermeability and stiffness. Typically, the amount of nano-scale filler is from about 0.5 wt % to about 30 wt %. In certain embodiments, nano-scale filler content is from about 2 wt % to about 10 wt %.

As described herein, a polymerizable C═C group is one that engages in radical addition reactions when treated by a radical generating technique. Covalent attachment of polymerizable C═C groups to a polymer backbone results, upon treatment with a radical generating technique, in the formation of a thermoset polymer network whose cross-links are made up of reacted pendant functionalities. The process for cross-linking a macromonomer requires the use of a radical generating technique. Free-radicals may, for example, be generated through the use of ultraviolet light, a chemical initiator, thermo-mechanical means, radiation, electron bombardment and the like. See any of the following references for a general discussion on radical generation techniques: Moad, G. Prog. Polym. Sci. 1999, 24, 81-142; Russell, K. E. Prog. Polym. Sci. 2002, 27, 1007-1038; and Lazar, M., Adv. Polym. Sci. 1989, 5, 149-223. An efficient macromonomer will crosslink substantially all polymerizable C═C functionalities when it is subjected to a small amount of radical initiation. Radical initiation can be accomplished by homolysis of organic peroxides, homolysis of hydroperoxides, homolysis of azo compounds, homolysis of bicumene, heating, or photolysis. When an organic peroxide is used as free-radical initiator, the organic peroxide is generally present in an amount between about 0.005 wt % and about 5.0 wt %. In some embodiments, organic peroxide is present in an amount between about 0.01 wt % and about 1.0 wt %. Alternately, polymer oxidation by heating in the presence of oxygen can serve as a free-radical source. Electron bombardment, irradiation, high-shear mixing, and activation of a photo-initiator by light can also generate free-radicals for the purpose of macromonomer crosslinking.

Referring to FIG. 1, a schematic is shown to demonstrate three synthetic methodologies used to prepare macromonomer of IIR by BIIR esterification chemistry.

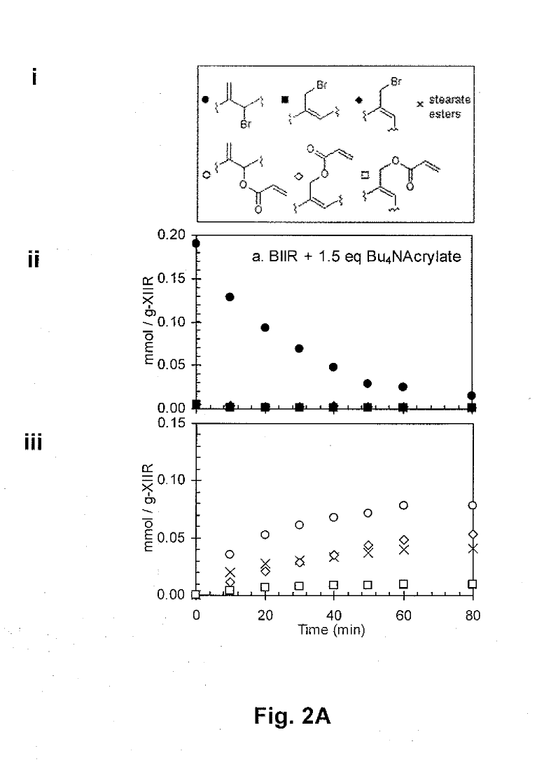

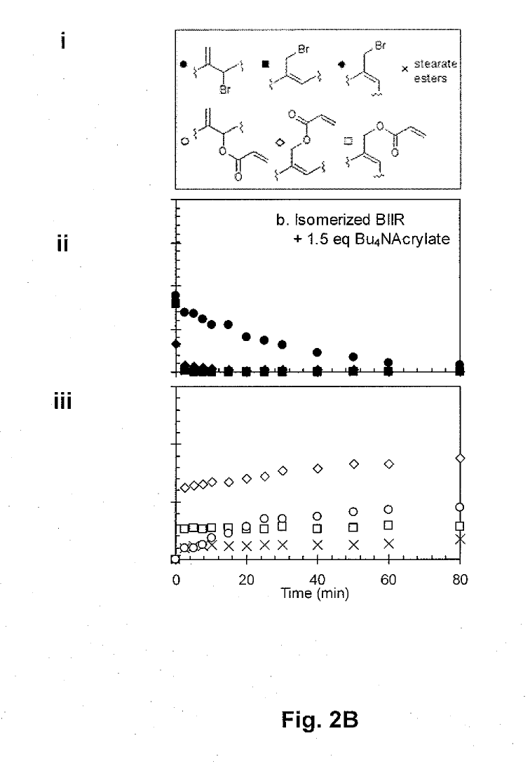

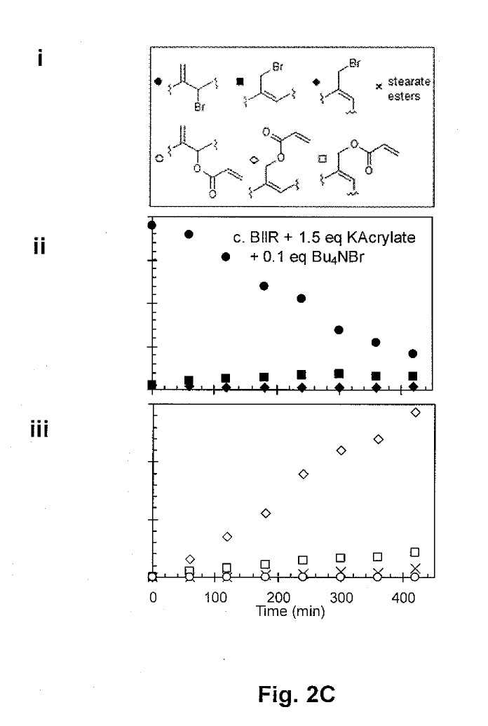

Referring to FIGS. 2A-C, plots are shown that display evolution of allylic bromide and acrylate ester concentrations in solution-borne IIR-g-AA preparations. These plots illustrate the successful preparation of acrylate ester derivatives of BIIR.

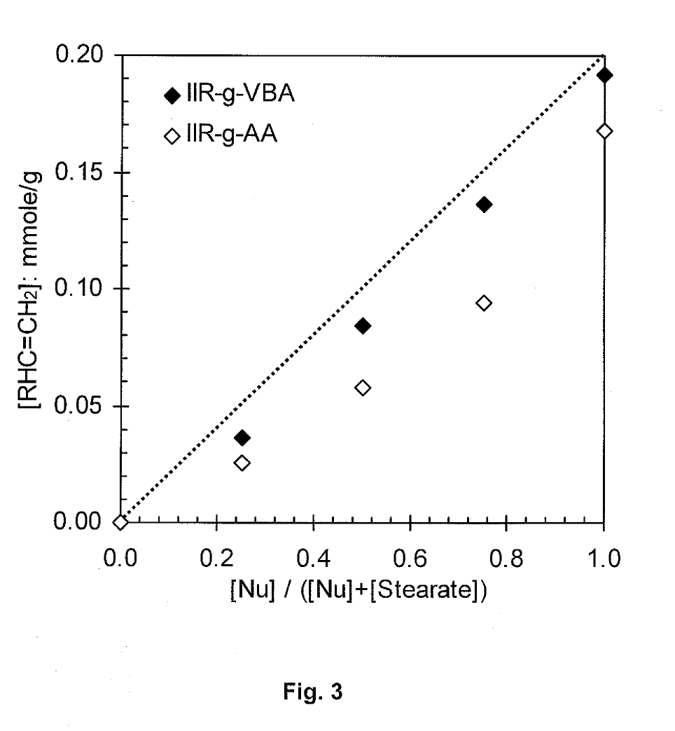

Referring to FIG. 3, a plot is shown that indicates final amounts of acrylate and vinylbenzoate ester contents of BIIR-derived macromonomers as a function of nucleophile mixture composition. This plot illustrates controllability of macromonomer composition.

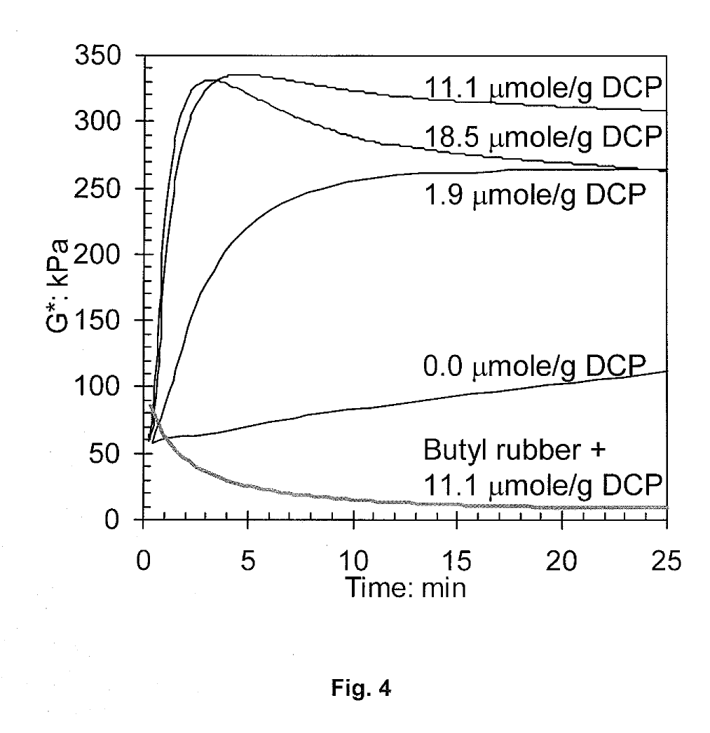

Referring to FIG. 4, a plot is shown that displays dynamics of peroxide-initiated IIR-g-AA crosslinking under different peroxide initiator concentrations. This data shows the ability of macromonomers to undergo radical cross-linking.

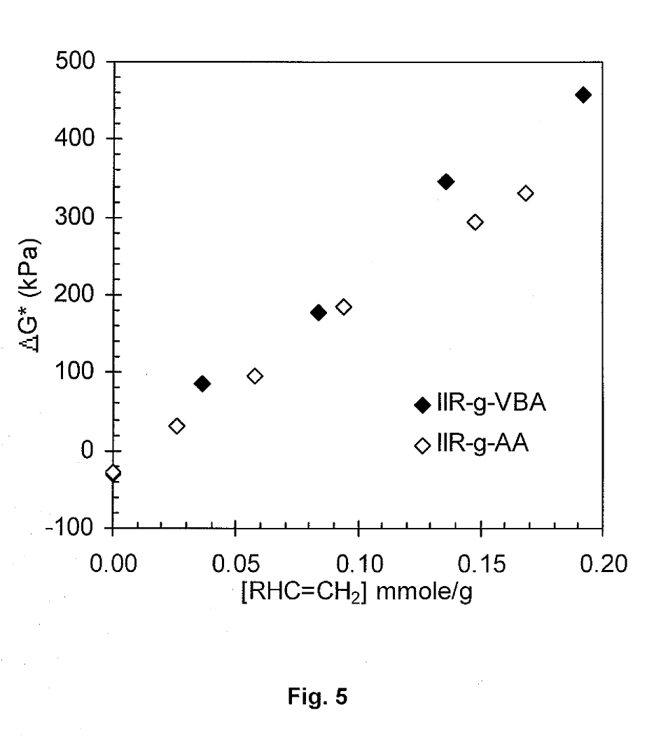

Referring to FIG. 5, a plot is shown that graphically presents peroxide-initiated cure yields of IIR-g-AA/stearate and IIR-g-VBA/stearate. This data illustrates the relationship between macromonomer composition and peroxide cure yield.

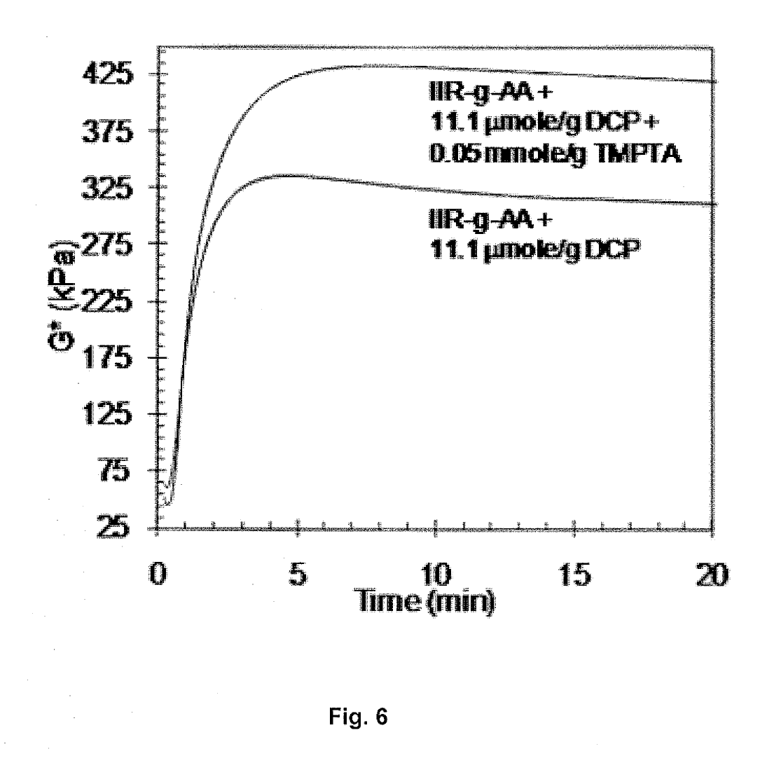

Referring to FIG. 6, a plot is shown that graphically presents dynamics of IIR-g-AA and co-agent-assisted IIR-g-AA cures. This data illustrates the increase in cross-link yield attainable through the use of a co-agent.

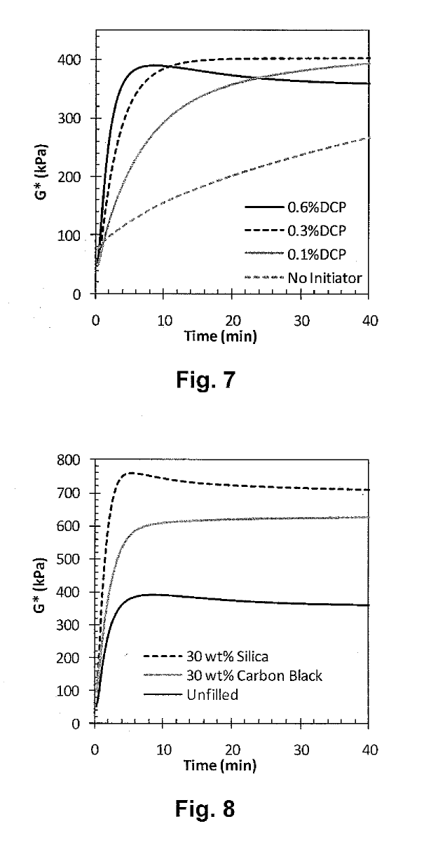

Referring to FIG. 7, a plot is shown that graphically presents dynamics of IIR-g-MBA crosslinking under different peroxide initiator concentrations. This data illustrates the ability of this macromonomer to undergo radical cross-linking.

Referring to FIG. 8 a plot is shown that graphically presents dynamics of crosslinking for unfilled IIR-g-MBA, IIR-g-MBA filled with 30 wt % of silica, and IIR-g-MBA filled with 30 wt % of carbon black. This data demonstrates the ability of macromonomers to undergo radical cross-linking in the presence of fillers.

As described in the following working examples and figures, gel-free macromonomers containing acrylate, styrenic and maleimide functionality were prepared and characterized by NMR spectroscopy. The prepared macromonomers had no gel prior to curing, and readily crosslinked when subjected to radical initiation techniques. Following crosslinking, thermoset products were obtained both in the absence of fillers, and in the presence of reinforcing fillers such as silica and carbon black.

Prepared exemplary macromonomers were both metal-free and halogen-free. NMR spectra indicated that the macromonomers were halogen-free as shown by the absence of allylic bromide protons. These macromonomers of modified butyl rubber were efficiently crosslinked using low concentrations of peroxide initiator. Crosslinking was efficiently achieved both in an absence of fillers and in the presence of fillers when macromonomers were mixed with carbon black or silica fillers. Cured macromonomer product was obtained and was characterized as discussed in Example #3. The cured macromonomer was metal-free and halogen-free since it was produced from halogen-free and metal-free macromonomers with no metals or halogens being added during the free-radical initiated crosslinking. In contrast, cured butyl rubber produced by previous methods is not halogen-free nor metal-free.

Cured macromonomer products are expected to have superior qualities such as good thermo-oxidative stability, exceptional compression set resistance, high modulus, and excellent gas impermeability. Accordingly, articles made from such crosslinked macromonomers, such as, for example, tire inner liners, gaskets, and sealants, can exploit these qualities without the presence of halogen and/or metal byproducts, or extractable peroxide initiator decomposition products.

The following working examples further illustrate the present invention and are not intended to be limiting in any respect.

### WORKING EXAMPLES

### Materials and Methods

Acrylic acid (AA) (anhydrous, 99%), 4-vinylbenzoic acid (VBA) (97%), Bu₄NOH (1.0 M in methanol), Bu₄NBr (99%), KOH (90+%), stearic acid (95%), butylated hydroxytoluene (BHT) (99%), maleic anhydride, p-amino benzoic acid, and dicumyl peroxide (DCP) (98%) were used as acquired from Sigma-Aldrich (Oakville, ON, Canada). Carbon black (black pearl 460) was used as received from Cabot (Boston, Mass., USA) and precipitated silica (HiSil 233) was used as received from PPG (Pittsburgh, Pa., USA).

¹H NMR spectra were acquired in CDCl₃ on a Bruker Avance-400 spectrometer (available from Bruker, Milton, ON, Canada). The extent of crosslinking as a function of time was monitored through measurements of dynamic shear modulus (G*) using an Alpha Technologies, Advanced Polymer Analyzer 2000 (Akron, Ohio, USA) operating at an oscillation frequency of 1 Hz and an arc of 3°.

### Example 1

### Macromonomer Syntheses

BIIR (LANXESS Bromobutyl 2030, allylic bromide content ˜0.2 mmol·g⁻¹) was provided by LANXESS Inc. (Sarnia, Canada). This “as received” BIIR contained approximately 0.2 mmol/gram of allylic bromide, which was distributed in a 90:0:10 ratio of Exo-Br:Z-BrMe:E-BrMe isomers. An “isomerized BIIR” derivative of “as received” material was prepared by heating under solvent-free conditions. BIIR (40 g) was charged to a Haake Polylab R600 batch mixing device (Thermo Scientific, Waltham, Mass., USA) at 115° C., 60 rpm for 2 hours. ¹H-NMR spectrum integration of δ 5.01 (Exo-Br, ═CHH, 1H, s); δ 4.11 (E-BrMe, ═CH—CH₂—Br, 2H, s), δ 4.09 (Z-BrMe, ═CH—CH₂—Br, 2H, s) revealed an Exo-Br:Z-BrMe:E-BrMe distribution of 44:40:16 (Parent, J. S. et al J. Polym. Sci. Part A: Polym. Chem. 2001, 39, 2019-2026).

BIIR was transformed into acrylate ester macromonomers (IIR-g-AA) as follows. BIIR (2 g, as received or isomerized) was dissolved in toluene (8 g) along with BHT (0.02 g) and the required amounts of nucleophile/phase transfer catalyst (0.19 g Bu₄NAcrylate or 0.063 g KAcrylate+0.013 g Bu₄NBr) under a nitrogen atmosphere, and heated to 85° C. using an oil bath. Samples withdrawn at intervals were precipitated from acetone and dried in vacuo at room temperature. IIR-g-AA materials for rheological testing were prepared on 15 g scale from as received BIER for 3 hours to ensure complete allylic bromide consumption. ¹H NMR (CDCl₃, δ ppm. ¹H-NMR integration for allylic bromides: δ 5.01 (Exo-Br, —CHH, 1H, s); δ 4.11 (E-BrMe. ═CH—CH₂—Br, 2H, s), δ 4.09 (Z-BrMe, ═CH—CH₂—Br, 2H, s). ¹H-NMR integration for acrylate esters: δ 5.27 (Exo-AAester, ═CHH, 1H, s); δ 4.68 (E-AAester, ═CH—CH₂—OCO—, 2H, s), δ 4.61 (Z-AAester, ═CH—CH₂—OCO—, 2H, s). ¹H-NMR integration for stearate esters: δ 4.51 (E-stearate, ═CH—CH₂—OCO—, 2H, s), δ 4.56 (Z-stearate, ═CH—CH₂—OCO—, 2H, s).

The dynamics data presented in FIG. 2a show that the Bu₄N acrylate system behaves in this manner, yielding Exo-ester and Z-ester products in greatest abundance, with E-ester product concentrations limited to the amount of E-BrMe functionality found in the starting material. The yield of IIR-g-AA preparations are impacted negatively by the Ca(stearate)₂ that is added as a surfactant and stabilizer during BIIR manufacturing. Unless deliberate efforts are made to remove stearate, then esterification products will contain a proportion of stearate ester. Under the reaction conditions used to generate FIG. 2a, 22% of the allylic bromide functionality within BIIR was converted to stearate byproduct. The balance was converted to the desired acrylate ester.

Reaction velocities are greatly improved by isomerizing BIIR prior to esterification.

FIG. 2b shows the dynamics of a reaction that started from a 44:40:16 ratio of ExoBr₂-BrMe:E-BrMe functionality. Conversion of the latter two isomers was complete within 5 min of exposing them to 1.5 eq Bu₄N acrylate, while Exo-Br consumption followed dynamics similar to those observed for the “as received” starting material (FIG. 2a). An additional benefit of pre-isomerization is a reduction of stearate byproducts, which constituted just 7% of final allylic ester concentrations. FIG. 2c illustrates the progression of such a phase transfer catalyzed process involving 1.5 eq K acrylate in conjunction with 0.1 eq Bu₄NBr. This process is highly selective for Z-ester production, yielding a very small amount of stearate ester byproduct. However, the reaction requires nearly an order of magnitude greater amount of time to reach full allylic bromide conversion.

### Example 2

### Control of Macromonomer Composition

BIIR esterifications were conducted with ratios of Bu₄N acrylate/Bu₄N stearate or Bu₄N vinyl benzoate/Bu₄N stearate according the procedure described in Example 1. ¹H NMR spectrum integration provided the relative amounts of stearate and monomer-derived esters. ¹H-NMR (CDCl₃) data for the vinylbenzoate ester derivative of BIIR (IIR-g-VB) is as follows: δ 8.01 (d, ═C—H, 2H), δ 7.43 (d, ═C—H, 2H), δ 6.75 (dd, ArCH═CH₂, 2H), δ 5.85 (dd, ArCH═CHH, 2H), δ 5.48 (dd, ArCH═CHH, 2H); Exo-VB ester: δ 5.56 (dd, —CHOCO—), δ 5.39 (═CHH, 1H, s), δ 5.03 (═CHH, 1H, s); Z-VBester: δ 4.83 (═CH—CH₂—OCO—, 2H, s), δ 5.46 (t, ═C—H); E-VB ester: δ 4.77 (═CH—CH₂—OCO—, 2H, s), δ 5.63 (t, ═C—H).

The yield data presented in FIG. 3 illustrate the effect of mixed carboxylate nucleophile concentrations on final RCH═CH₂ contents. The IIR-g-AA system was quite sensitive to deliberate additions of Bu₄N stearate to the reaction mixture. For example, a 50:50 mixture of Bu₄N acrylate: Bu₄N stearate gave a product containing 0.06 mmol/g of acrylate ester and 0.14 mmol/g of stearate ester. Vinylbenzoate alkylations were more competitive, providing pendant styrene functionality in proportions nearly equal to the ratio of Bu₄N benzoate:Bu₄N stearate.

### Example 3

### Macromonomer Curing Dynamics

Pressed samples of elastomer were coated with the required amount of a stock solution of DCP in hexanes, and allowed to dry prior to passing three times through a 2-roll mill. This mixed compound was cured in the rheometer cavity at 170° C. at a 3° oscillation arc and a frequency of 1 Hz.

FIG. 4 illustrates the cure dynamics for a commercial grade of butyl rubber (IIR) and IIR-g-AA derivatives. The susceptibility of IIR toward degradation when treated with dicumyl peroxide (DCP) at 170° C. is evident from the order of magnitude drop of its complex modulus (G*) from its initial value of 86 kPa. In contrast, IIR-g-AA demonstrated significant G* increases irrespective of peroxide loading. The best cure performance was recorded when 11.1 μmole/g DCP was used to activate the 0.15 mmol/g of bound acrylate functionality. Less peroxide produced a lower state of cure within the 25 min illustrated in FIG. 4, while a higher DCP loading resulted in a small degree of cure reversion, due to the dominance of IIR backbone fragmentation after all acrylate functionality was consumed.

### Example 4

### Macromonomer Cure Yields

The dependence of the final G* plateau on monomer content is illustrated in FIG. 5 for the IIR-g-AA/stearate and IIR-g-VBA/stearate derivatives whose compositions were described in Example 2. IIR-g-stearate did not cure under the action of DCP, but fragmented to produce a negative change in modulus (AG*=−30 kPa). However, as little as 0.03 mmol/g of acrylate functionality produced a net positive response, with G* increasing linearly with bound monomer content. At a given RCH═CH₂ content, IIR-g-VBA marginally outperformed IIR-g-AA.

### Example 5

### Co-Agent-Assisted Macromonomer Cures

The close relationship between cure yield and monomer content suggests that the amount of allylic bromide functionality within the BIIR parent material will impose an upper limit on the attainable cure yield of IIR-g-AA. However, ultimate G* values can be boosted by including multi-functional co-agents such as trimethylolpropane triacrylate (TMPTA). FIG. 6 shows the evolution of an IIR-g-AA cure formation that contained 0.05 mmol/g of TMPTA, which reached a G* value of 432 kPa, compared to 285 kPa for the peroxide-only system.

### Example 6

### Maleimido-Ester Macromonomer Curing Dynamics

Maleic anhydride (5 g, 0.05 mol) and p-amino benzoic acid (6.9 g, 0.05 mol) were dissolved in acetone (20 g) and the mixture was stirred for 30 min at room temperature. The resulting precipitate was separated by vacuum filtration and dried. This maleamic acid (11.9 g, 0.05 mol) was mixed with acetic anhydride (20 g, 0.2 mol) and sodium acetate (2 g, 0.025 mol) in a round bottom flask and heated to 85° C. for 15 min. p-Maleimidobenzoic acid (MBA) was recovered by precipitating the contents in cold water purified twice by dissolution/precipitation in THF/hexane.

BIIR (55 g) was dissolved in THF to make a 10 wt % solution prior to the addition of TBAB (2.73 g, 8.25 mmol) and sealing the mixture in a 1 L autoclave. The autoclave was pressurized with nitrogen gas to 200 psi and heated to 85° C. for 120 min to rearrange Exo-Br to more reactive E,Z-BrMe isomers. The autoclave was cooled to room temperature prior to the addition of maleimidobenzoic acid (5.37 g, 24 mmol), KOH (2.31 g, 41 mmol) and N-phenylmaleimide (5 g, 28 mmol). The autoclave was pressurized to 200 psi with nitrogen gas and heated to 75° C. for 8 hr. The fully converted product, IIR-g-MBA, was recovered by precipitation from acetone and dried under vacuum.

IIR-g-MBA was mixed with varying amounts of DCP and cured in the rheometer cavity. FIG. 7 illustrates the observed dynamics of IIR-g-MBA cures under different DCP loadings.

### Example 7

### Curing Dynamics of Filled Maleimido-Ester Macromonomer

The IIR-g-MBA described in Example 6 was compounded with 0.6 wt % DCP, and filler in a two-roll mill, and cured in the rheometer cavity. FIG. 8 illustrates the dynamics of DCP-initiated cures of an IIR-g-MBA derivative for an unfilled sample, a sample containing 30 wt % of precipitated silica, and a sample containing 30 wt % of carbon black. Both fillers provided reinforcement without adversely affecting crosslink density, with silica providing a higher overall modulus than carbon black.

It will be understood by those skilled in the art that this description is made with reference to certain embodiments and that it is possible to make other embodiments employing the principles of the invention which fall within its spirit and scope as defined by the claims.

1. A macromonomer, which comprises a polymeric main chain comprising an olefinic moiety, and a plurality of side chains that comprise a polymerizable C═C moiety;
wherein the polymerizable C═C moiety is a substituted or unsubstituted styrenic moiety, a substituted or unsubstituted vinylbenzoate, or a substituted or unsubstituted maleimido moiety; and
which is a polymer that homopolymerizes when initiated by a free-radical initiator.

2. The macromonomer of claim 1, which is a poly(isobutylene-co-isoprene) derivative, a polyisobutylene-co-methylstyrene) derivative, or a polyolefin derivative.

3. The macromonomer of claim 1, wherein substituents of the substituted styrenic moiety, the substituted vinylbenzoate or the substituted maleimido moiety are functional substituents.

4. The macromonomer of claim 1, wherein the polymerizable C═C moiety comprises styrene, ascorbate, cinnamate, 2-vinylbenzoate, 3-vinylbenzoate, 4-vinylbenzoate, 4-maleimidobenzoate, 3-maleimidobenzoate, 2-maleimidobenzoate, maleimidocaproicate, or a combination thereof.

5. The macromonomer of claim 4, wherein the polymerizable C═C moiety is substituted.

6. Crosslinked macromonomer prepared by reacting the macromonomer of claim 1 with a free-radical initiator.

7. (canceled)

8. The crosslinked macromonomer of claim 6, wherein the free-radical initiator is: a chemical free-radical initiator, a photoinitiator, heat, heat in the presence of oxygen, electron bombardment, irradiation, high-shear mixing, photolysis (photo-initiation), electron beam radiation, or radiation bombardment.

9. The crosslinked macromonomer of claim 8, wherein the chemical free-radical initiator is an organic peroxide, a hydroperoxide, bicumene, dicumyl peroxide, di-t-butyl peroxide, an azo-based initiator, or homolysis of an organic peroxide.

10.-11. (canceled)

12. Poly(isobutylene-co-methystyrene) having vinylbenzoate ester pendant groups.

13. Poly(isobutylene-co-methystyrene) having maleimidobenzoate pendant groups.

14. A method of crosslinking isobutylene-rich elastomers, comprising:
modifying halogenated isobutylene-rich elastomers to form halo-free elastomers by replacing substantially all halide substituents with polymerizable groups that comprise a polymerizable C═C moiety;
exposing the halo-free elastomers to a free-radical initiator; and
allowing reactions to occur such that crosslinking-bonds form and cured product is obtained.

15. The method of claim 14, wherein the polymerizable C═C moiety comprises: a substituted or unsubstituted styrenic moiety, a substituted or unsubstituted vinylbenzoate, or a substituted or unsubstituted maleimido moiety.

16. A method for making macromonomer comprising:
esterifying Exo-Br by reacting it with R¹₄N⁺R²COO⁻; and
obtaining E,Z-ester, Exo-ester, and R¹₄NBr.

17. The method of claim 16, further comprising removing substantially all R¹₄NBr from the esterification product.

18. A method for making macromonomer comprising:
isomerizing Exo-Br;
obtaining E,Z-BrMe;
esterifying E,Z-BrMe by reacting it with R¹₄N⁺R²COO⁻; and
obtaining E,Z-ester and R¹₄NBr.

19. The method of claim 18, further comprising purifying E,Z-ester.

20. A method for making macromonomer comprising:
reacting Exo-Br with K⁺ RCOO— and R¹₄N⁺Br; and
obtaining E,Z-ester, Exo-ester and KBr.

21.-22. (canceled)
